(19) United States
(12) Patent Application Publication
(10) Pub. No.: US 2009/0226047 A1
(43) Pub. Date: Sep. 10, 2009

(54) Apparatus and Method of Processing Image and Human Face Detection System using the smae

(76) Inventors: Chi-Chang Yu, Hsin-Chu City (TW); Chia-Kai Liang, Hsin-Chu City (TW); Ming-Yang Wu, Hsin-Chu City (TW); Brian Sung, Hsin-Chu City (TW)

Correspondence Address: HDLS Patent & Trademark Services, P.O. BOX 220746, CHANTILLY, VA, 20153-0746, US

(21) Appl. No.: 12/249,055

(22) Filed: Oct. 10, 2008

(30) Foreign Application Priority Data
Mar. 4, 2008 (TW) 097107576

(51) Int. Cl. G06K 9/00

(52) U.S. Cl. 382/118

(57) ABSTRACT

An image processing apparatus includes a first register, a second register and an adder. The second register reads a number of pixels from a sub-window image in turn. The adder adds the pixels in the second register and stored values in the first register to output a number of adding calculation values. The adding calculation values are returned to the first register and are saved as stored values. In addition, the present invention relates to an image processing method and a human face detection system using the above image processing apparatus.

### BACKGROUND

The present invention relates to the visual processing and object recognition technology, and particularly to an image processing apparatus and method for calculating and processing a visual image, and a human face detection system using the apparatus and method.

For a long time, machines passively receive information from various inputting devices, such as a keyboard, inputted text file, and so on, while do not actively acquire information from outside. In order to allow machines to contact with outside and actively acquire information therefrom, the machine vision technology has been developed.

Up to now, the development of the machine vision technology has undergone a very long process. Based on persistent effort of researchers, new information technology and medium manner appear, which facilitate a development of an efficient and friendly man-machine conversation model, and the new man-machine conversation model no longer depends on the conventional inputting devices. In addition, an improving of price quality (i.e., price to performance ratio) and a lowering of a video acquisition cost facilitate the computer vision system developing to desktop system and embedded system, which means that the computer vision system can be installed in every electronic system. In the future, an intelligent electronic product having high-level vision system can make people's life more convenient.

Human face visual processing is an important content of the computer vision processing. In a human face analysis process, identification, state, intention or other information of a user can be acquired from an image (e.g., an image taken by a digital camera) thereof, and then the computer makes a corresponding response according to the acquired information (for example, analyzing mood through observing face expression and giving a corresponding response).

Human face analysis includes face detection and face recognition. Initially, the face analysis mainly focuses on human face recognition field. Compared with the human biological feature recognition system such as fingerprint, retina, iris, gene, palmprint, and so on, human face recognition is relatively direct and friendly. Human face recognition technology is widely used in various fields, such as criminal identification recognition, verification of status card and driving license, monitor of bank and custom, automatic door guard system, video meeting, study on the intellectualized robot, medicine, and so on. In addition, Human face recognition technology can be used to trace focus in photography.

In the early years, the face recognition method is performed basis on an acquired front face image or on a presupposition for easily acquiring a face image. With a widening of an application of the human face analysis and an increasing of a requirement of exploiting practical system, this face recognition method under the presupposition condition can not meet the practical requirement. People require exactly and quickly detecting whether or not a human face image exists in real complex background images, if detected, returns a position, dimension, pose of the human face. Except for being used to focus, the information can also be used to assist quickly recognizing the identification of the human. If the human face detecting technology tends to practice, an on-line detecting is necessarily required. Therefore, a detecting speed is a key factor considered by each practical system.

Presently, literatures in out country and abroad have various human face detecting methods, and many international meetings and periodicals relate to a thesis of the human face detecting. The human face detecting technology begins to be widely used in new man-machine interface, searching basis on context, digital video processing, image on-line detecting, and other fields.

For example, P. Viola and M. J. Jones release a paper named “Robust Real-Time Face Detection” in “International Journal of Computer Vision”, 57(2), 137-154, 2004. In this paper, P. Viola set forth a rectangle is used as a feature vector of the human face detection, named a rectangle feature. The rectangle feature is sensitive to some simple configurations such as edge, line segment, and can be configured for describing a direction (e.g., horizontal, vertical, diagonal) of a given configuration. Referring to FIG. 1, a facial feature can be described by the rectangle feature. For example, a color of eyes is darker than that of the face, a color of two side of a bridge of a nose is darker than that of the bridge of the nose, and a color of mouth is darker than that of periphery thereof.

Referring to FIG. 2A to 2D, P. Viola defines five kinds of rectangle combinations as feature template. The feature template is composed of two or more congruent rectangles horizontally or vertically adjacent with each other. The feature template includes at least a white rectangle and at least a black rectangle arranged in an alternating manner, and a top left corner arranges a white rectangle. A feature value of the feature model is equal to a sum of the white rectangle minus a sum of the black rectangle.

Referring to FIG. 3, an integral image is applied to compute the feature value of an image. Each feature value can be computed in a constant time by the integral image retrieving through visiting every pixel only once, so as to process the human face image extremely rapidly. A detailed analysis process is described in the following.

In FIG. 3, regarding a point A(x, y) in an image, an integral image ii(x, y) of the point A is defined in a formula (1):

$$ii ( x , y ) = {\sum }_{{x}^{′} \leq , {y}^{′} \leq y} i ( {x}_{,}^{′} {y}^{′} ) ; \qquad ( 1 )$$

wherein i(x′, y′) is an original image of a point (x′, y′) and is a color value of the point (x′, y′). With respect to a grayscale image, a color value is from above zero to about 255. With respect to a color image, it can be transformed into the grayscale according to a color space of the human face, thereby facilitating acquiring a corresponding color value.

The ii(x, y) can be computed by the formulas (2) and (3).

s(x, y)=s(x1, y−1)+i(x, y) (2);

ii(x, y)=ii(x−1, y)+s(x, y) (3);

wherein s(x, y) is a cumulative row sum of the point (x, y) along x direction, named as a row integral sum, and is defined in a formula (4):

$$s ( x , y ) = {\sum }_{{x}^{′} \leq x} i ( {x}^{′} , y ) ; \qquad ( 4 )$$

wherein s(x, 0)=0, ii(0, y)=0.

If a size of an image is equal to m×n, thus an integral matrix (i.e., the integrals of all of the pixels in the image) is defined in a formula (5):

$$[ \begin{matrix}ii ( 1 , 1 ) = ii ( 0 , 1 ) + s ( 1 , 1 ) & ii ( 2 , 1 ) = ii ( 1 , 1 ) + s ( 2 , 1 ) & & ii ( m - 1 , 1 ) = ii ( m - 2 , 1 ) + s ( m - 1 , 1 ) & ii ( m , 1 ) = ii ( m - 1 , 1 ) + s ( m , 1 ) \\ s ( 1 , 1 ) = s ( 1 , 0 ) + i ( 1 , 1 ) & s ( 2 , 1 ) = s ( 2 , 0 ) + i ( 2 , i ) & … & s ( m - 1 , 1 ) = s ( m - 1 , 0 ) + i ( m - 1 , 1 ) & s ( m , 1 ) = s ( m , 0 ) + i ( m , 1 ) \\ ii ( 1 , 2 ) = ii ( 0 , 2 ) + s ( 1 , 2 ) & & & & ii ( m , 2 ) = ii ( m , 1 ) + s ( m , 2 ) \\ s ( 1 , 2 ) = s ( 0 , 1 ) + i ( 1 , 2 ) & & & & s ( m , 2 ) = ii ( m - 1 , 2 ) + i ( m , 2 ) \\ ⋮ & & ⋱ & & ⋮ \\ ii ( 1 , n - 1 ) = ii ( 0 , n - 1 ) + s ( 1 , n - 1 ) & & & & ii ( m , n - 1 ) = ii ( m - 1 , n - 1 ) + s ( m , n - 1 ) \\ s ( 1 , n - 1 ) = s ( 1 , n - 2 ) + i ( 1 , n - 1 ) & & & & s ( m , n - 1 ) = ii ( m , n - 2 ) + i ( m , n - 1 ) \\ ii ( 1 , n ) = ii ( 0 , n ) + s ( 1 , n ) & ii ( 1 , n - 1 ) = ii ( 0 , n - 1 ) + s ( 1 , n - 1 ) & … & ii ( m - 1 , n ) = ii ( m - 2 , n ) + s ( m - 1 , n ) & ii ( m , n ) = ii ( m - 1 , n ) + s ( m , n ) \\ s ( 1 , n ) = s ( 1 , n - 1 ) + i ( 1 , n ) & s ( 1 , n - 1 ) = s ( 1 , n - 2 ) + i ( 1 , n - 1 ) & & s ( m - 1 , n ) = ii ( m - 1 , n - 1 ) + i ( m - 1 , n ) & s ( m , n ) = ii ( m , n - 1 ) + i ( m , n )\end{matrix} ] ; \qquad ( 5 )$$

every pixel of the image is retrieving through visited only once, and is iterated m×n×2 times, thereby obtaining the integral matrix described in the formula (5).

Referring to FIG. 4, the integral image is applied to compute a sum of pixels of a certain image region. For example, pixels sum of a region D is computed by integral images of points 1, 2, 3, 4. The reason is depicted in the following:
ii1=pixels sum of a region A;
ii2=pixels sum of the region A+pixels sum of a region B;
ii3=pixels sum of the region A+pixels sum of a region C;
ii4=pixels sum of the region A+pixels sum of the region B+pixels sum of the region C;
   the above equations are solved to get a formula (6):

The pixels sum of a region D=ii4+ii1−(ii2+ii3) (6);

According to the first feature template shown in FIG. 2A, a feature value of the feature template shown in FIG. 5=pixels sum of the region A−the pixels sum of the region B. (7); According to above-described equations:

The pixels sum of the region A=ii4+ii1−(ii2+ii3);

The pixels sum of the region B=ii6+ii3−(ii4+ii5);

Therefore, the feature template shown in FIG. 5=(ii4−ii3)−(ii2−ii1)+(ii4−ii3)−(ii6−ii5) (8).

From above, the computing of the feature value of the rectangle feature only relates to integral images of end points of the rectangle feature, and does not relate to coordinate values. Therefore, no matter what is the size of the rectangle feature, a time for computing the feature value is a constant, and all computing processes are involved in algorithms

According to the above formula (8), in FIGS. 2A to 2B, the feature template composed of two white and black rectangles, and a difference of pixels sum of the feature template is computed by six reference rectangles. In FIG. 2C, the feature value of the feature template composed of three rectangles is computed by eight reference rectangles. In FIG. 2D, the feature value of the feature template composed of four rectangles is computed by nine reference rectangles.

In above-described human face image processing method, P. Viola set forth that the rectangle in images is used as the feature vector for human face detection, then the feature value of the rectangle feature is computed by the integral image, and according to the feature value of the rectangle feature in various positions of the image, the image of human face is judged.

The method set forth by P. Viola has improved the human face image processing speed. However, the method has some following shortcomings.

Firstly, in computing the integral matrix of the pixels of the image, the method can only computes one pixel ii(x, y) at a time, but can not calculate a number of pixels simultaneously, therefore, the computing speed is relatively slow.

Secondly, in computing the integral matrix of the pixels of the image, the integral matrix value of each pixel ii(x, y) is iterated many times so as to cause the reiteration of the computing process. In addition, the larger a range of an image, and the larger a computing quantity, thereby lowering the computing speed.

Thirdly, in computing the integral matrix of the pixel of the image, because the computing quantity is relatively large, a high speed processor and a large-capacity memory are required to perform the computing process, as a result, a high cost is caused and the method is not easy integrated with an integrate circuit.

Therefore, how to improve human face image processing method set forth by P. Viola is an important problem for human face image processing technology, so as to compute the integral matrix of the acquired image with a faster speed, lower the capacity of the required memory, easier integrate with the integrate circuit, realize miniaturization and modular of human face detection system.

### BRIEF SUMMARY

An image processing apparatus with a quickly computing speed is provided.

An image processing apparatus with a quickly computing speed and having a simple configuration is provided.

An image processing method with a quickly computing speed is provided.

A human face detection system with a quickly computing speed is provided.

A human face detecting method with a quickly computing speed is provided.

The image processing apparatus includes a first register, a second register, and an adder. The first register includes M numbers of stored values, and an initial value of each stored value is zero. The second register reads I numbers of pixels from a sub-window having M×N numbers of pixels in turn, I is a positive integer that greater than 1 and less than M×N, M and N are positive integer respectively that greater than 1. The adder adds the I numbers of pixels read by the second register and the corresponding I numbers of stored values stored in the first register to acquire I numbers of adding calculation values. I numbers of adding calculation values are returned to the first register and are saved as I numbers of stored values.

An image processing method includes the steps of: providing a sub-window image containing M×N numbers of pixels, M and N being positive integers that greater than 1; providing a first register containing M numbers of stored values; reading I numbers of pixels from the sub-window image, I being a positive integer that greater than 1 and less than M×N; and performing a first operation, adding stored values of I numbers of pixels read by the second register and I numbers of stored values in the first register to acquire I numbers of adding calculation values, returning the I numbers of adding calculation values to the first register and saving the I numbers of adding calculation values as I numbers of stored values of the first register.

A human face detection system includes an image processing unit, an image integral computing unit and a human face detection unit. The image processing unit is used to divide a sub-window image into M×N numbers of pixel regions and evaluate each of the pixel regions, thereby outputting a processed result. The image integral computing unit includes multiple registers for parallel computing the processed result, thereby outputting a computed result. The human face detection unit is used to detect and judge whether or not the computed result contains a human face image.

A human face detection method includes the steps of: providing a sub-window image; dividing the sub-window image into M×N numbers of pixels and evaluating each of the pixel to acquire a processed result; computing the processed result by an image integral computing unit comprising multiple registers, thereby acquiring an integral matrix, an accumulated value of pixels and a sum of square value of pixels; according to the integral matrix, computing a given rectangle region of the sub-window image to acquire a feature value corresponding to the given rectangle region; according to the feature value, the accumulated value of pixels, and the sum of square value of pixels, applying a feature value quick detection step to the sub-window image and acquiring a detected result; according to the detected result, computing M×N numbers of pixels of the sub-window image one by one, thereby acquiring M×N numbers of feature values; and according to M×N numbers of feature values, applying a feature value general detection step to the sub-window image.

The above-described image processing apparatus additionally includes an accumulated value register, and an initial value of a stored value stored in the accumulated value is zero. The adder adds the I numbers of pixels and the stored value in the accumulated value register to acquire an accumulated value. The accumulated value is returned to the accumulated register and saved as a stored value.

The above-described image processing apparatus additionally includes a discrete quantity register and a discrete quantity computing unit. An initial value of a stored value stored in the discrete quantity register is zero. The discrete quantity computing unit is configured for apply a discrete quantity calculation to I numbers of pixels and the stored value stored in the discrete quantity register, thereby acquiring a discrete quantity calculation value. The discrete quantity calculation value is returned to the discrete quantity register and is saved as a stored value of the discrete quantity register.

Multiple registers are used to simultaneously/parallel process and compute the stored values of the pixels in the sub-window image, the computing speed of the image integral computing unit is multiplicatively quickened. In the process of the image integral computing unit computing the integral matrix of image pixels, the multi-bit registers are used to register intermediate results, thus the stored value of each pixel II(x, y) does not need to be recalculated by the reiteration manner, greatly saving the reiteration steps and quickening the computing speed of the image integral computing unit. Because the computing speed is greatly quickened, a relative low speed processor and low capacity memory can be applied to the present human face detection system, thereby lowering a cost of the system. In addition, the image integral computing unit has a simple configuration and is easy to integrate with the integrate circuit, so as to miniaturize the human face detection system and lower the cost thereof, thereby achieving a better practicability.

The feature value quick detection unit and the feature value general detection unit cooperatively detect the sub-window image, the sub-window images which do not contain the human face image are rapidly eliminated by the feature value quick detection unit; the feature value quick detection unit and the feature value general detection unit can simultaneously run the detection process, so the detecting speed and efficiency of the human face detection system are greatly improved, thereby causing the human face detection system having better practicability and better performance of on-line detection. In addition, the feature value calculator can be made of an integrate circuit, so a compact structure and a high computing speed are acquired. The processed sub-window image is saved in the image memory by the local storage manner, which facilitates sequential units access the sub-window image data, thereby improving a running efficiency of the human face detection system

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is schematic view of a rectangle feature of a human face detection in accordance with a related art.

FIGS. 2A to 2D are schematic views of rectangle feature templates in accordance with the related art.

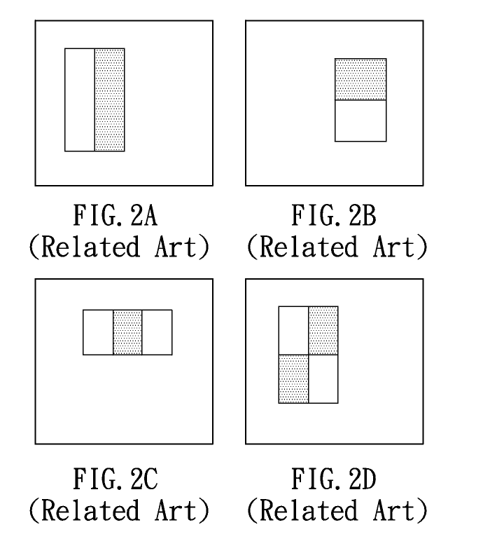

FIG. 3 is schematic view of an integral image of an image region in accordance with the related art.

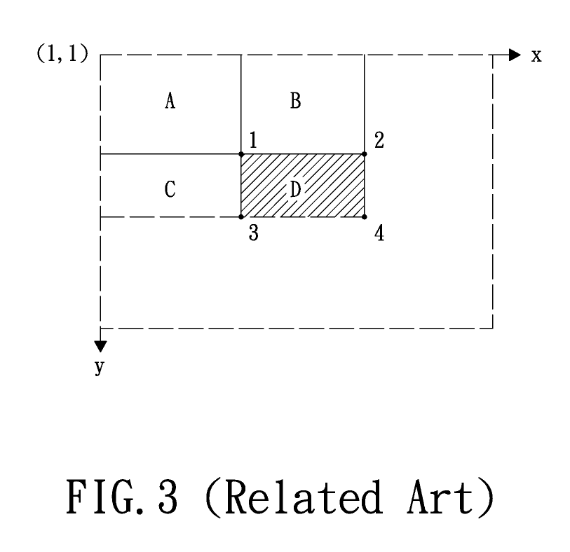

FIG. 4 is similar to FIG. 3, but showing a view of calculating an integral image in accordance with the related art.

FIG. 5 is a schematic view of calculating a feature value of the rectangle feature in accordance with the related art.

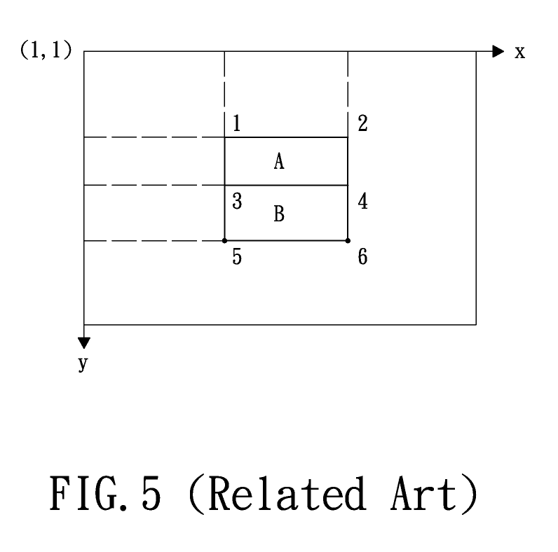

FIG. 6 is a schematic view of a human face detection system in accordance with a first embodiment.

FIG. 7 is a schematic view of a computer visual image containing human face images.

FIG. 8 is a circuit diagram of an image integral computing unit computing the sub-window image in a first period of time, according to a first embodiment.

FIG. 9 is a circuit diagram of the image integral computing unit according to a second embodiment.

FIG. 10 is a circuit diagram of the image integral computing unit according to a third embodiment.

FIG. 11 is a circuit diagram of the image integral computing unit according to a fourth embodiment.

FIG. 12 is a schematic view of a human face detection system in accordance with the first embodiment.

FIG. 13 is a circuit diagram of a feature value calculator according to the first embodiment.

FIG. 14 is a logic flow diagram of a feature value quick detection unit in accordance with the first embodiment.

FIG. 15 is a logic flow diagram of a feature value general detection unit in accordance with the first embodiment.

FIG. 16 is a flow chart of a main control unit in accordance with the first embodiment.

FIG. 17 is a timing sequence diagram of the main control unit processing the sub-window image according to the first embodiment.

### DETAILED DESCRIPTION

An exemplary embodiment of an image processing technology is provided. The image processing technology includes an image processing apparatus and an image processing method applied in processing a computer vision image. The image processing technology improves the method of calculating the feature value of the rectangle feature by the integral image provided by P. Viola, thereby having a rapidly computing speed, low capacity memory, and easy to integrate with the integrate circuit.

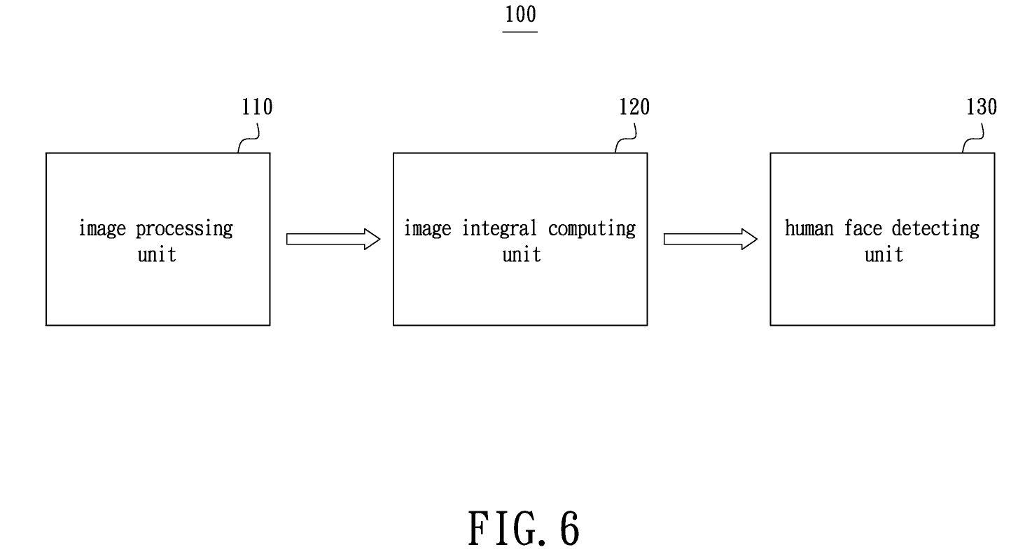

Referring to FIG. 6, (is a block diagram of a human face detection system) a human face detection system 100 includes an image processing unit 110, image integral computing unit 120, and a human face detection unit 130. The image processing unit 110 is used to process an image captured by a digital camera, a camera lens or other video device, and is configured for searching every part of the captured image and localizing the part which probably contains a human face feature by a sub-window. The image integral computing unit 120 divides the sub-window image into M×N numbers of image regions; evaluates each image region with different feature vectors by a series of feature templates (e.g. rectangle feature); processes the sub-window image including M×N numbers of image regions into M×N numbers of pixels (e.g. 24×24 numbers pixels) having feature values; thereby facilitating the processing of sequential units. The processed M×N numbers of pixels are inputted into the image integral computing unit 120, an integral matrix, a pixel average value, and a pixel standard deviation value of the M×N numbers of pixels are computed, and the computed results are inputted into the human face detection unit 130. The human face detection unit 130 compares the integral matrix, the pixel average value, and the pixel standard deviation value of the M×N numbers of pixels with reference values prestored in a database, so as to detect whether or not the sub-window image including M×N numbers of pixels contains a human face image, and to judge a position, size, expression, status and other human face information in the sub-window image.

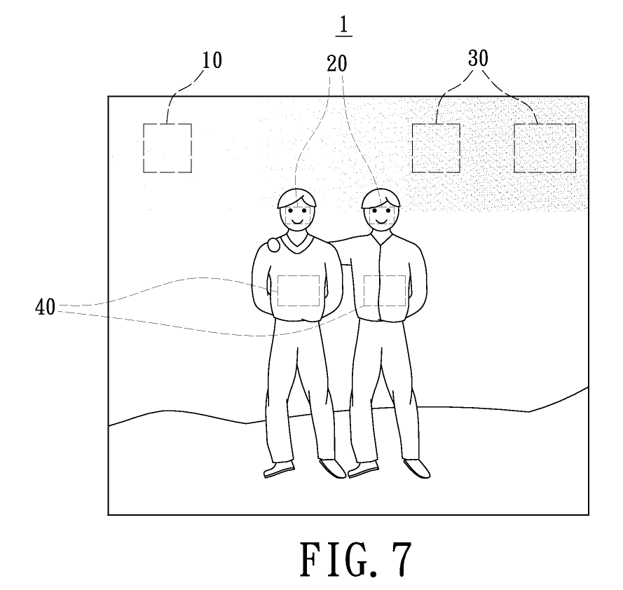

Referring to FIG. 7, a computer visual image 1 includes a series of sub-window images, such as a sky image 10, a human face image 20, an architecture image 30, and a dress image 40. The human face detection system 100 rapidly extracts the human face image 20 from the complex visual image 1, and eliminates non-face images. In order to recognize the human face image 20 and the non-face image, the human face detection system 100 is required to rapidly compute/process each sub-window image, thereby facilitating a detection and judgment of the human face detection unit 130. A computing speed and a veracity of the image integral computing unit 120 determine a detecting speed of the human face detection system 100. Therefore, in the present invention, the image integral computing unit 120 capable of high-speed and accurately computing the sub-window image is provided and is described in the following.

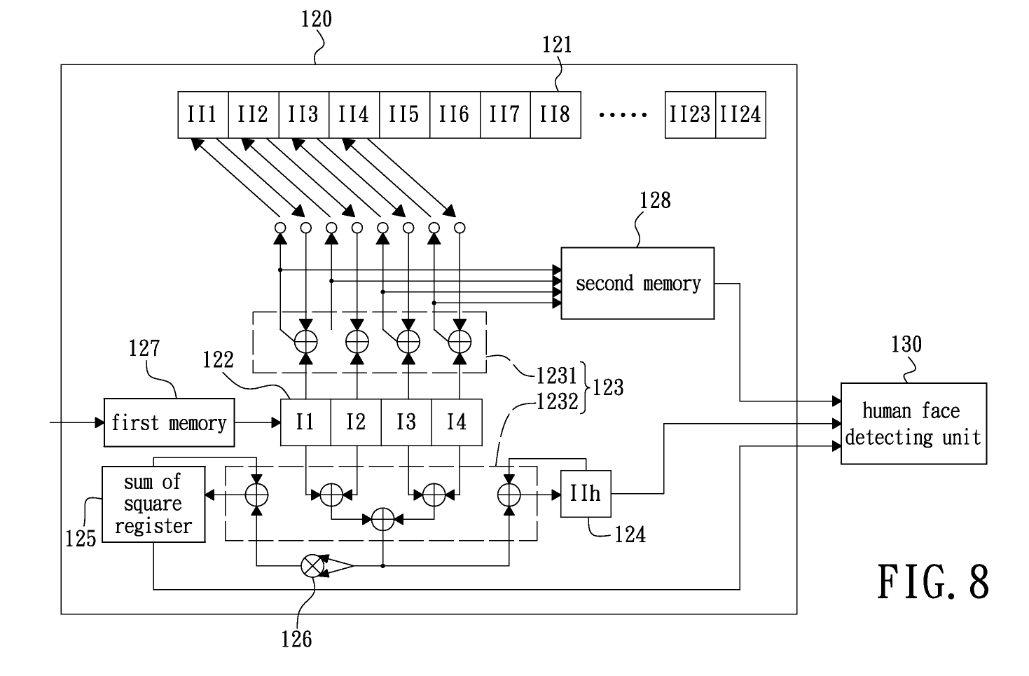

Referring to FIG. 8, the image integral computing unit 120 includes a first register 121, a second register 122, an adder 123, an accumulated value register 124, a sum of square register 125, a multiplier 126, a first memory 127, and a second memory 128. For example, a given sub-window image includes 24×24 numbers of pixels, the first register 121 contains twenty-four store bits (e.g., II0˜II23), the second register 122 contains four store bits (e.g., I1˜I4).

An initial value of a stored value of the first memory 127 is zero, and the first memory 127 is used to receive the 24×24 numbers of pixels having feature values outputted by the image processing unit 110, and the 24×24 numbers pixels are saved as 24×24 numbers of stored values. Because the first memory 127 employs a local storage mode, and the image integral computing unit 120 does not require storing or accessing image information to an external memory, thus a high computing speed is achieved.

Initial values of stored values of the four store bits I1 to I4 contained in the second register 122 are zero, according a certain order, he second register 122 every time reads the stored values of four pixels from the stored values of the 24×24 numbers of pixels stored in the first memory 127. For example, according to a row column order, firstly, pixels from (0, 0) to (0, 23) are read in that order; secondly, pixels from (1, 0) to (1, 23) are read in that order; in such manner, until the pixel (23, 23) is read. In addition, according to a column row order, firstly, pixels from (0, 0) to (23, 0) are read in that order; secondly, pixels from (0, 1) to (23, 1) are read in that order; in such manner, until the pixel (23, 23) is read. Four pixels are read every time and are separately saved as the stored values of the store bits I1 to I4 of the second register 122. Four stored values of the second register 122 are separately output to the adder 123. In the present embodiment, in a first period of time, the second register 122 reads the pixels from (0, 0) to (0, 3) from 24×24 numbers of pixels according to the row column order.

The adder 123 can be an integrated structure. According to a function in the image integral computing unit 120, the adder 123 includes a first adder 1231 and a second adder 1232. In the first period of time, the first adder 1231 receives the stored values of four pixels (i.e., the pixels from (0, 0) to (0, 3)) separately saved in the four store bits (i.e., the store bits from I1 to I4) of the second register 122, and pluses each of the above four stored values and a corresponding stored value (the initial value of the stored value is zero) saved in the four store bits from I1 to II 4 of the first register 121. That is, the stored value of the pixel (0, 0) saved in the store bit I1 pluses the stored value saved in the store bit II 1; the stored value of the pixel (0, 1) saved in the store bit I2 pluses the stored value saved in the store bit II 2; the stored value of the pixel (0, 2) saved in the store bit I3 pluses the stored value saved in the store bit II 3; and the stored value of the pixel (0, 3) saved in the store bit I4 pluses the stored value saved in the store bit II 4. Except for being separately returned to the four store bits from II 1 to II 4 of the first register 121 and separately saved as four corresponding stored values, the above four adding calculation values are also separately returned to the four store bits corresponding to the pixels from (0, 0) to (0, 3) of the second memory 128 and separately saved as four corresponding stored values (the initial value of each of the stored value is zero). The second adder 1232 receives the four stored values of four pixels from (0, 0) to (0, 3) saved in the four store bits from I1 to I4 of the second register 122, and runs an adding calculation, i.e., plus the above four stored values of the four pixels saved in the four store bits from I1 to I4, thereby acquiring and outputting an accumulated value. The accumulated value plus a stored value (an initial value of the stored value is zero) saved in the accumulated value register 124, and the adding calculation value is returned to the accumulated value register 124 and is saved as a stored value. In addition, the accumulated value is also returned to the multiplier 126 and a multiplicative square calculation is run, thereby acquiring a square value. The square value pluses the stored value (an initial value of the stored value is zero) saved in the sum of square register 125, and the acquired adding calculation value is returned to the sum of square register 125 and is saved as a stored value.

The second memory 128 is used to store an adding calculation values, i.e., sums of the stored values of the store bits from I1 to I4 of the second register 122 and the stored values of the store bits from II0 to II23 of the first register 121 computed by the first adder 1231, into store bits of the second memory 128 according to an input order, thereby forming a stored value integral matrix.

The accumulated value register 124 is used to store the accumulated value of the stored values of pixels of the sub-window image including 24×24 numbers of pixels.

The sum of square register 125 is used to store a sum of square value of the stored values of pixels of the sub-window image including 24×24 numbers of pixels.

The human face detection unit 130 receives the stored value integral matrix saved in the second memory 128, the accumulated valued saved in the accumulated value register 124 and the sum of square value saved in the sum of square register 125; and compares the aforesaid values with the reference value prestored in the database to detect whether or not the sub-window image contains a human face and to judge a position, size, expression, status and other human face information in the sub-window image.

Stored values of twenty-four store bits in the twenty-fourth row are separately equal to twenty-four adding calculation values by separately adding the stored values of the pixels from (0, 0) to (0, 23), pixels from (1, 0) to (1, 23) . . . the pixels from (23, 0) to (23, 23), thereby constructing a 24×24 numbers of stored value integral matrix. The stored value saved in the accumulated value register 124 is an accumulated value of the pixels from (0, 0) to (23, 23). The stored value saved in the sum of square register 125 is a sum of square of respective accumulated values of one hundred and forty-four groups of stored values, i.e., the stored values of the pixels (0, 0) to (0, 3), . . . the stored values of the pixels (23, 20) to (23, 23).

In a process of the image integral computing unit 120 computing the stored value integral matrix, the first register 121 registers the accumulated value of the stored values of each row, the stored value integral matrix of each pixel ii(x, y) do not need to be recalculated by a reiteration manner, but the stored value saved in the second register 122 plus the stored value saved in the first register 121 is performed to acquire a desired integral matrix value. This computing manner greatly reduces reiteration steps and quickens the computing speed of the image integral computing unit 120.

In the first embodiment of the present invention, in order to rapidly recognize the human face image regions and non-face image regions, the image integral computing unit 120 provides a method for computing an average value and a standard deviation value of stored values of pixels of the sub-window image including 24×24 numbers of pixels. By computing the average value and the standard deviation which describes a random discrete quantity of pixels, simple background patterns such as the sky image 10 shown in FIG. 7 can be rapidly eliminated, other images whose colors and pixels are distributed uniformly, e.g., water surface and concrete floor, can also be rapidly eliminated by the average value and the standard deviation value. According to aforesaid accumulated value register 124 and the sum of square register 125, the accumulated value register 124 is used to store the accumulated value of the stored values of the 24×24 numbers of pixels in the sub-window image. The sum of square register 125 is used to store a sum of square value of the stored values of the 24×24 numbers of pixels in the sub-window image. According to the stored values of the accumulated value register 124 and the sum of square register 125, the average value and the standard deviation value are computed as follows.

A given stored value of a pixel is denoted by II(x, y), wherein x=0˜23, y=0˜23, the average value of the stored values of the pixels in the sub-window image is denoted by A, the standard deviation value of the stored values of pixels is denoted by B, the stored value of the accumulated value register 124 is denoted by IIh, the stored value of the sum of square register 125 is denoted by SQ, the store bit of the second register 122 is denoted by I and I=4, the accumulated value of the second register 122 each time is denoted by Σ, and Σ is an output value of the adder 123 each time, the number of the pixels of the sub-window image is denoted by W, and W=24×24, therefore, the number of Σ denoted by K, and K=W/I=144.

Σ0=II(0,0)+II(0,1)+II(0,2)+II(0,3);

Σ1=II(0,4)+II(0,5)+II(0,6)+II(0,7);

. . .

Σ143=II(23,20)+II(23,21)+II(23,22)+II(23,23);

According to FIGS. 8A and 8B, a following conclusion is acquired:

IIh=Σ0+Σ1+Σ2+ . . . +Σ143 (9);

SQ=Σ0²+Σ1²+Σ2²+ . . . +Σ143² (10)

According to probability theory, with respect to the random discrete quantity of the pixels in the image:
an average value=an accumulated value/the number (denoted by K) of the pixels;
a deviation=an average value of the sum of square−a square of the average value; and
a standard deviation value=a square root of the deviation value.

In the first embodiment, the method of computing the standard deviation value is different from the conventional method. Because the second register 122 is used to read the sub-window image, therefore, the random discrete quantity of the sub-window image is computed on the basis of I stored values of I bits of pixels stored in the second register 122.

In the first embodiment, the standard deviation value is computed by sub-regions (a size is I bits of pixels), which is capable of representing a distribution status of the random discrete quantity of a bigger sub-region in the sub-window image. Therefore, compared with only computing a distribution status of the random discrete quantity of the smallest region of the prior art, the present method judges whether or not the human face exists with a rapidly speed and a high veracity. When the size of the sub-region is smaller, the feature value of the image rectangle is more unclear, therefore, it is easier to judge whether or not the human face exists in the larger sized image region.

In the present invention, the average value A and the standard deviation value B of the stored values of the pixels of the sub-window image are not limited to be computed by such method. For example, other computing method in the prior art can also be used to compute the average value A and the standard deviation value B.

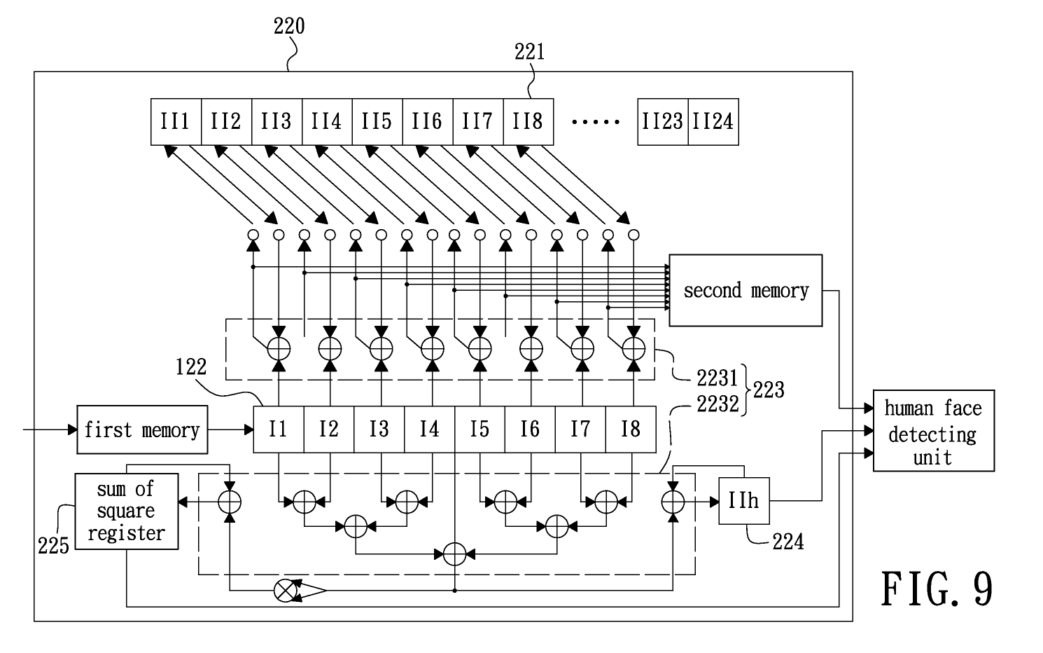

Referring to FIG. 9, a circuit diagram of the image integral computing unit according to a second embodiment is shown. Dissimilar to the image integral computing unit 120 of the first embodiment, in the image integral computing unit 220 of the present embodiment, the second register 222 has eight stored values, and the computing bit in the first adder 2231 and the second adder 2232 of the adder 223 is increased accordingly. Due to the increasing of the stored values of the second register 221 and the computing bit of the adder 223, the computing speed of the image integral computing unit 220 is quickened accordingly.

In the present embodiment, the number of the sub-window image is not limited to be 24×24, 8×8, 16×16, 48×48, 64×64 format, even can be 16×24, 24×48, 48×64 format.

In the present embodiment, the number of the stored values of the second register 222 is not limited to be a fixed value. The number of the stored values of the second register 222 can be less than that of the first register 221, e.g., the number is four, eight, twelve; or equal to that of the first register 221, e.g., the number is twenty-four; or even larger than that of the first register 221, e.g., the number is forty-eight or sixty-four. When the accumulated value register 224 and the sum of square register 225 are self-governed register, the number of the stored values of the second register 222 is a multiple or a submultiple of the number of the stored values of the first register 221, thereby saving the store bits of the registers and avoiding a waste of the store bits. In addition, when the number of the stored values of the second register 222 is larger than the multiple or submultiple of the number of the stored values of the first register 221, so long as practical used store bits are set, redundant store bits can be left unused or set in other use.

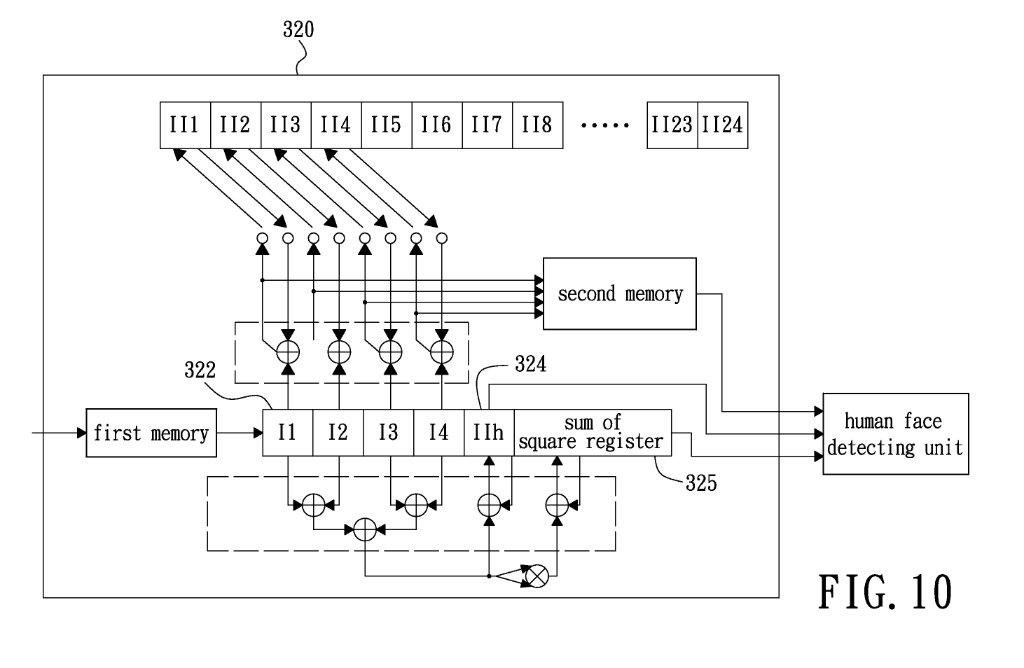

Referring to FIG. 10, a circuit diagram of the image integral computing unit according to a third embodiment is shown. Dissimilar to the first and second embodiments, in the image integral computing unit 320 of the present embodiment, the accumulated value register 324, the sum of square register 325 and the second register 322 are integrated into one register, thereby simplifying a configuration of the image integral computing unit 320.

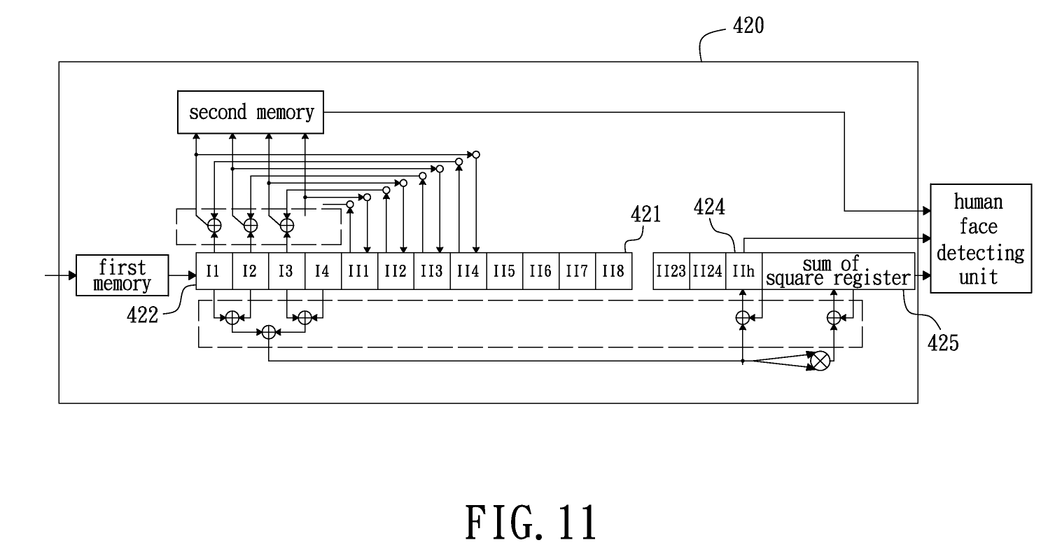

Referring to FIG. 11, a circuit diagram of the image integral computing unit according to a fourth embodiment is shown. Dissimilar to the image integral computing unit of the first to third embodiments, in the image integral computing unit 420 of the present embodiment, the first register 421, the second register 422, the accumulated value register 424 and the sum of square register 425 are integrated into one register, thereby simplifying a configuration of the image integral computing unit 420.

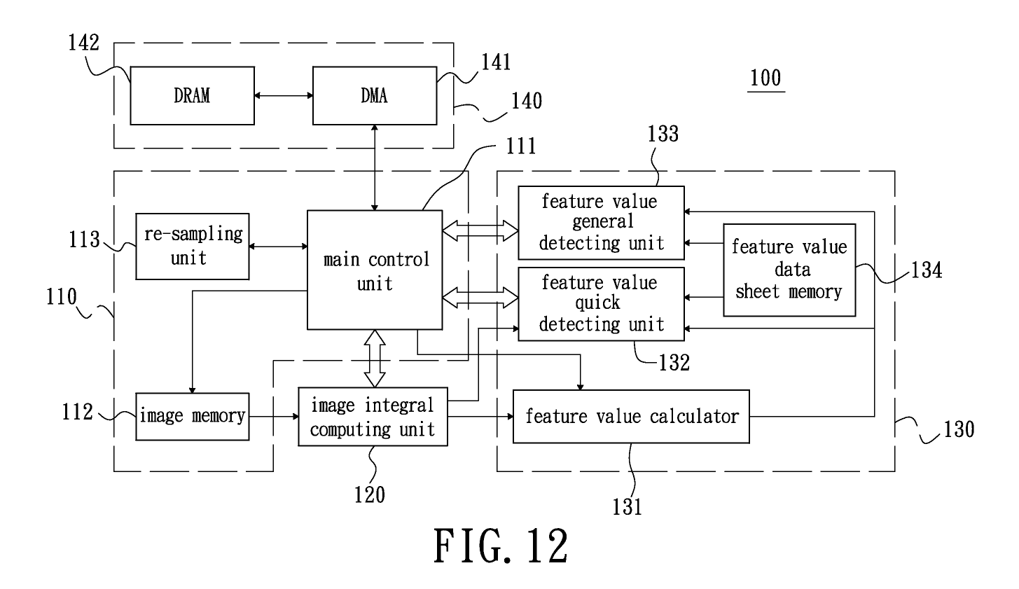

Furthermore, a human face detection system applying the aforesaid image integral computing unit 120 is additionally provided. Referring to FIG. 12, a human face detection system 100 in accordance with a first embodiment is described. The human face detection system 100 includes an image processing unit 110, an image integral computing unit 120 and a human face detection unit 130. The image processing unit 110 includes a main control unit 111, an image memory 112 and a re-sampling unit 113. The human face detection unit 130 includes a feature value calculator 131, a feature value quick detection unit 132, a feature value general detection unit 133, and a feature value data sheet memory 134. In addition, the human face detection system 100 is in communication with an external data access unit 140 by the main control unit 111. The external data access unit 140 includes a direct memory access (DMA) 141 and a dynamic random access memory (DRAM) 142. The main control unit 111 read images and communication signals stored in the DRAM 142 by the DMA 141, and stores the detected human face images into the DRAM 142.

The image data stored in the DRAM 142 is generally a whole image as shown in FIG. 7, and is stored in the DRAM 142 in a lattice manner. In a process of judging a human face, the human face detection system 100 reads judges the sub-window image stored in the DRAM 142 according to an coordinate of the sub-window image, so as to recognize whether or not the sub-window image contains a human face, localizes the human face, and even compares the sub-window image with the human face prestored in the database to recognize a status feature of the human face image.

The main control unit 111 is a central processing unit of the human face detection system 100, and is configured for receiving external image data and communication signals of external systems; controlling a running of the image processing unit 110, image integral computing unit 120 and the human face detection unit 130; complete controlling processing, computing and detecting of the image data; and returning the detected result of the image data to the external systems. In the first embodiment, according to the predetermined coordinate values of images, the main control unit 111 reads the image data stored in the DRMA 142 by the DMA 141; intercepts a sub-window image with a fixed size from a whole image of the DRMA 142; controls the re-sampling unit 113 to re-sample the read image data; divides the sub-window image into M×N image regions, evaluates each of the image regions with different feature vectors by a series of feature templates (e.g., a rectangle feature); processes the sub-window image including M×N numbers of image regions into another sub-window image including M×N numbers of pixels which have feature values (e.g., the sub-window image including 24×24 numbers of pixels), thereby facilitating the computing and processing of sequential units. The processed sub-window image is saved in the image memory 112 by the main control unit 111. The processed sub-window image is saved in the image memory 112 by the local storage manner, so it facilitates sequential units accessing the image data of the sub-window image, thereby improving a running efficiency of the human face detection system 100.

The main control unit 111 controls the image integral computing unit 120 reading the image memory 112, and inputs the processed M×N numbers of pixels stored in the image memory 112 into the image integral computing unit 120. The image integral computing unit 120 performs an integral matrix, a pixel accumulating and a pixel sum of square computing process, and separately saves the computed result into the accumulated value register 124, the sum of square register 125 and the second memory 128.

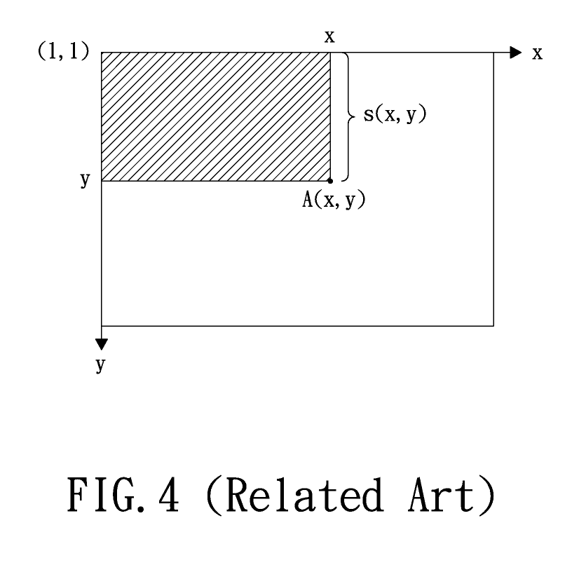

According to the integral matrix value, the pixel accumulated value and the pixel sum of square value computed by the integral calculating unit 120, the human face detection unit 130 controlled by main control unit 111 performs a judging process. The feature value calculator 131 of the human face detection unit 130 is used to compute the feature value of a given region in the sub-window image. According to the description of FIG. 4 of the prior art, a sum of pixels in a certain image region, e.g., a sum of pixels in the region D, is computed by integral images of points 1, 2, 3, 4. According to formula (6) of prior art, the sum of pixels in the region D is ii4+ii1−(ii2+ii3). In other words, so long as coordinate values of four vertexes of rectangle of the region D, the sum of pixels of the region D can be computed. Regarding each of the sub-window image, an initial coordinate is a fixed coordinate (0, 0), because the sub-window image has a fixed size, therefore, a space between the feature rectangle of the sub-window image and the initial coordinate (0, 0) is a fixed value. Therefore, regarding the computing of the sum of pixels of a given feature rectangle, so long as the coordinate value of four vertex of the given feature rectangle and the initial coordinate (0, 0) are known, a coordinate difference between the four vertex and the original coordinate is the desired sum of pixels of the given feature rectangle.

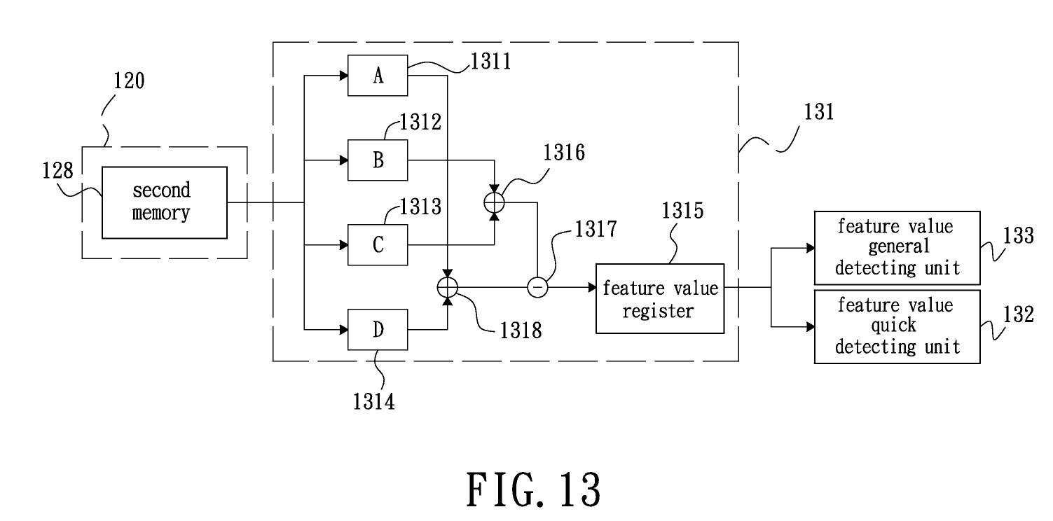

Referring to FIG. 13, a circuit diagram of the feature value calculator according to a first embodiment is shown. The feature value calculator 131 includes an A register 1311, a B register 1312, a C register 1313, a D register 1314, a feature value register 1315, two adder 1316 and 1318, and a subtracter 1317. The feature value calculator 131 is provided for realizing a computing function of the formula (6) according to in the prior art, so as to compute the sum of pixels of a given rectangle region. The A register 1311, B register 1312, C register 1313 and D register 1314 separately read integral values of four vertex of a given rectangle region in the sub-window image from the second memory 128. An integral value of the A register 1311 and an integral value of the D register 1314 are added by the adder 1318, thereby obtaining a first adding calculation result. An integral value of the B register 1312 and an integral value of the C register 1313 are added by the adder 1316, thereby obtaining a second adding calculation result. A difference calculation between the first and second adding calculation result are run by the subtracter 1317 so as to achieve a computed result of the sum of pixels of the given rectangle region, and the computed result is saved in the feature value register 1315. The computed result is the feature value of the given rectangle region. The main control unit 111 acquires the feature value of the given region of the sub-window image by controlling the feature value calculator 131 reading the coordinate values of four vertexes of the given rectangle region, thereby facilitating the feature value quick detection unit 132 and the feature value general detection unit 133 running a next judging process. The feature value calculator 131 can be made up of an integrate circuit, thus a compact structure and a quickly computing speed of the feature value calculator 131 are acquired.

According to the feature value of the given rectangle region of the sub-window image computed by the feature value calculator 131, the accumulated value and the sum of square value computed by the integral calculating unit 120, the main control unit 111 controls the feature value quick detection unit 132 running a first step of judging process of human face recognition to eliminate the sub-window images which do not contain human face image. Regarding a generic image, the number of the sub-window images which contain human face image is generally less than the number of the sub-window images which do not contain human face image. Therefore, in the present embodiment, the feature value quick detection unit 132 is used to quickly detect and eliminate the sub-window images which do not contain human face image so as to quicken the detecting speed of the human face detection system 100. Referring to FIG. 12, the feature value quick detection unit 132 controlled by the main control unit 111 reads the accumulated value and the sum of square value of pixels from the image integral computing unit 120, and reads the feature value of the given rectangle region of the sub-window image from the feature value calculator 131, so as to judge and recognize the sub-window image. A logic flow of the judging and recognizing is described in the following.

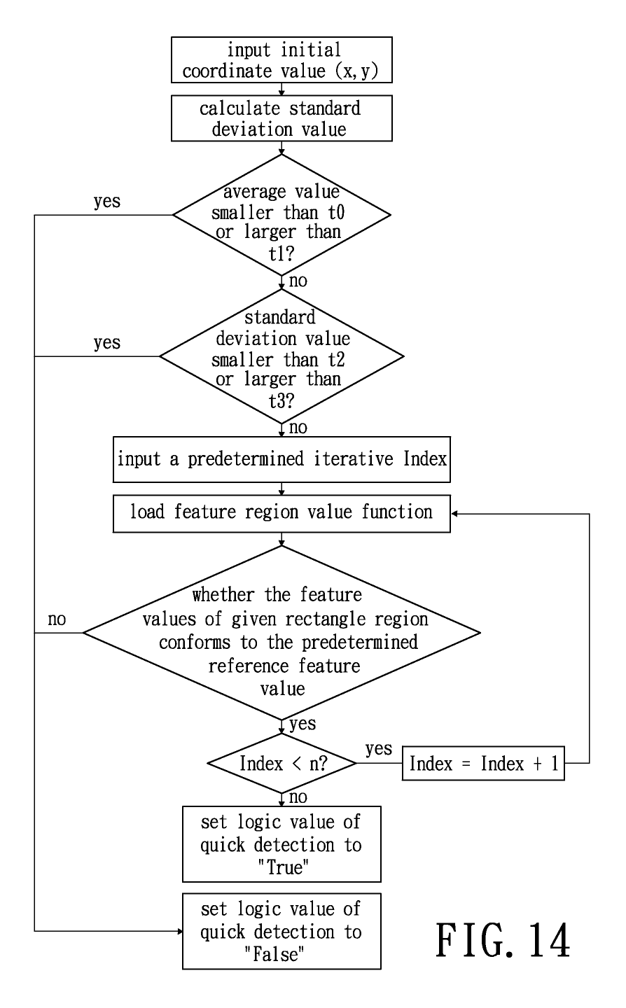

Referring to FIG. 14, a logic flow diagram of the feature value quick detection unit in accordance with a first embodiment is shown. Regarding the sub-window images which do not contain the human face image, e.g., the sky image 10, the architecture image 30 and the dress image 40 shown in FIG. 7, the average value and the standard deviation value of the pixels are different from those of the human face image 20. Too large or twotoo small average value and the standard deviation value indicates that the processed sub-window images do not contain the human face image. Therefore, according to such difference, the average value and the standard deviation value of the sub-window images are judged, and the sub-window images which do not contain the human face image are eliminated. In order to simplify the structure of the human face detection system, in FIG. 14, the image integral computing unit 120 is configured for computing the accumulated value and the sum of square value of the pixels of the sub-window image, and not configured for computing the average value and standard deviation value of the pixels. Firstly, the main control unit 111 provides an initial coordinate value of the pixels of the sub-window image detected by the feature value quick detection unit 132, according to the initial coordinate value, the coordinate values of four vertexes of the given rectangle region of the sub-window image are judged. Secondly, according to a predetermined formula, and the accumulated value and the sum of square value of the pixels provided by the image integral computing unit 120, the feature value quick detection unit 132 computes the standard deviation value of the pixels. Thirdly, a judging flow of the average value and the standard deviation value of the pixels of the sub-window image is run. The sub-window images which include too large or too low average value and standard deviation value are eliminated in the judging flow, and a logic value of the feature value quick detection unit 132 is a false value. In FIG. 14, the average value ranging from t0 to t1 and the standard deviation value ranging from t2 to t3 are predetermined through an experiment manner. After the average value and standard deviation value are judged, the sub-window image is in a next stage, i.e., recognizing whether or not the sub-window image contains the human face image by judging the feature value of the given rectangle region of the sub-window image.

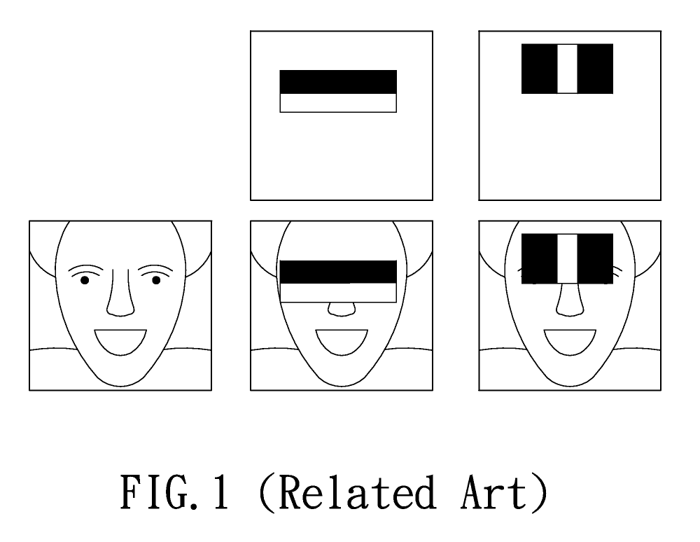

Referring to FIG. 1, regarding the human face image in different races, shapes and sizes, a position of some parts such as the left eye, right eye, lip, nose in the human face is fixed relative to the whole face, and the shape of those parts can be determined by a rectangle region. Therefore, in the present invention, the human face image is detected and recognized by judging the image feature value of the rectangle region located in those parts of the sub-window image. The method has a high veracity for eliminating the sub-window image which do not contain non-face image. As shown in FIG. 14, first of all, the feature value quick detection unit 132 inputs a predetermined iterative Index (an initial value of the Index is zero) for ascertaining the number n of the given rectangle regions to be judged, e.g., n is in a range from three to four. Second, a feature region value function (denoted by Feature [Index]) of a given rectangle region corresponding to the left eye, right eye, lip and nose of the human face is loaded in the feature value data sheet memory 134 shown in FIG. 12. Feature [0] represents a space between a coordinate value of a first predetermined region and the initial coordinate value, i.e., a space between x-coordinate and y-coordinate values of the first predetermined region and the initial x-coordinate and y-coordinate values. Feature [1] represents a space between a coordinate value of a second predetermined region and the initial coordinate value. Feature [2] represents a space between a coordinate value of a third predetermined region and the initial coordinate value. According to the initial coordinate value (x, y) and the feature region value function of Feature [Index], the feature value calculator 131 reads the feature values of the given rectangle region of the sub-window image, and compares the read features value with the predetermined reference feature values prestored in the feature value data sheet memory 134, so as to detect and judge whether or not the feature value of the given rectangle of the sub-window image inosculates with the feature value of the left eye, right eye, lip, nose in the human face, thereby judging whether or not the sub-window image contain the human face image. If the feature value of the given rectangle region of the sub-window image is different from the predetermined reference feature value prestored in the feature value data sheet memory 134, thus the sub-window image does not contain the human face image, a logic value of the feature value quick detection unit 132 is a false value, and the detecting and judging process is passed and a feature value of a next given rectangle region of is detected and judged. If all of the predetermined Feature [Index] have been iteratively judged, the logic value of the feature value quick detection unit 132 is a true value, in this circumstance, there is a high probability that the sub-window image contains the human face image, and the sub-window image is required to be generally recognized by the feature value general detection unit 133. When the logic value of the feature value quick detection unit 132 is a false value, the corresponding sub-window image is directly eliminated and is not required to be detected and judged by the feature value general detection unit 133. Such detecting method by stages greatly improves the detecting speed and detecting veracity of the human face detection system 100, thereby improving the detecting efficiency of the human face detection system 100 and causing the human face detection system 100 having better practicability and better performance of on-line detection.

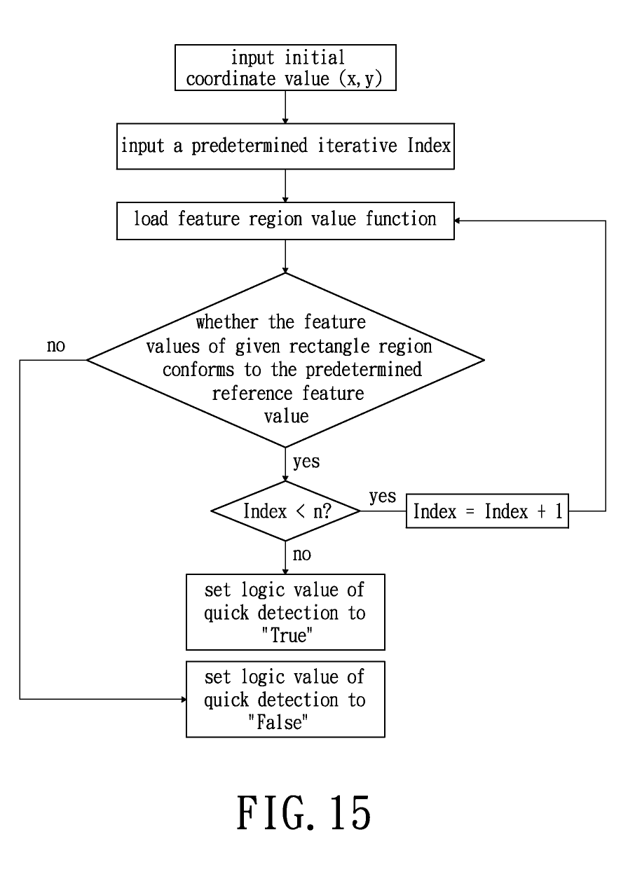

Referring to FIG. 15, a logic flow diagram of the feature value general detection unit in accordance with a first embodiment is shown. Dissimilar to the detection method of the feature value quick detection unit 132, the feature value general detection unit 133 aims at the sub-window image which contains M×N numbers of pixels. The feature region value function Feature [Index] of a given rectangle corresponding to various parts of the human face is loaded by the feature value data sheet memory 134 shown in FIG. 12. According to the initial coordinate value (x, y) and the feature region value function Feature [Index], the M×N feature values corresponding to the M×N numbers of pixels of the sub-window image is read from the feature value calculator 131, and are compared with the predetermined reference feature value prestored in the feature value data sheet memory 134, so as to detect and judge whether or not the given rectangle of sub-window image inosculates with the various parts of the human face, thereby ascertaining whether or not the sub-window image contains the human face image.

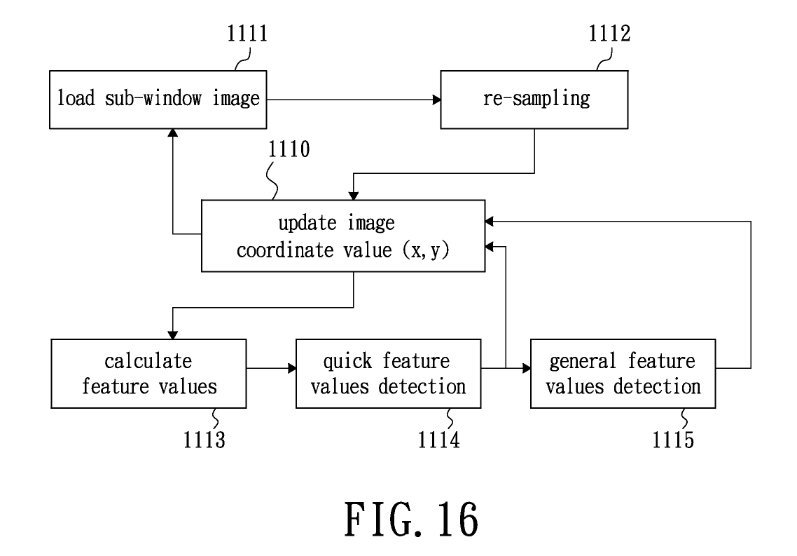

Referring to FIG. 16, a flow chart of the main control unit in accordance with a first embodiment is shown. When the human face detection system 100 accomplishes a detection and recognition process of a sub-window image, a new process of detecting and recognizing the human face begins. In a first step 1110, the main control unit 111 updates the image coordinate value parameter (x, y). In a second step 1111, according to the updated image coordinate value parameter (x, y), the main control unit 111 loads a new sub-window image in the DRAM 142. In a third step 1113, the re-sampling unit 113 controlled by the main control unit 111 reads the data of the new sub-window image, and samples and evaluates the read data of the new sub-window image. The sub-window image which undergoes the sampling and evaluating processes is stored in the image memory 112 by the main control unit 111. In a fourth step 1113, the image integral computing unit 120 computes and processes the sub-window image which undergoes the sampling and evaluating processes. In a fifth step 1114, according to the result processed by the image integral computing unit 120, the feature value quick detection unit 132 quickly detects and judges the sub-window image, so as to eliminate the sub-window images which do not contain the human face image. After being detected and judged by the feature value quick detection unit 132, if the sub-window image has a probability of containing the human face image, a sixth step 1115 is run. As shown in the sixth step 1115, the feature value general detection unit 133 generally detects and judges every region of the sub-window image which has a probability of containing the human face image one by one, so as to ascertain whether or not the sub-window image contains the human face image, or additionally ascertain a status feature of the human face.

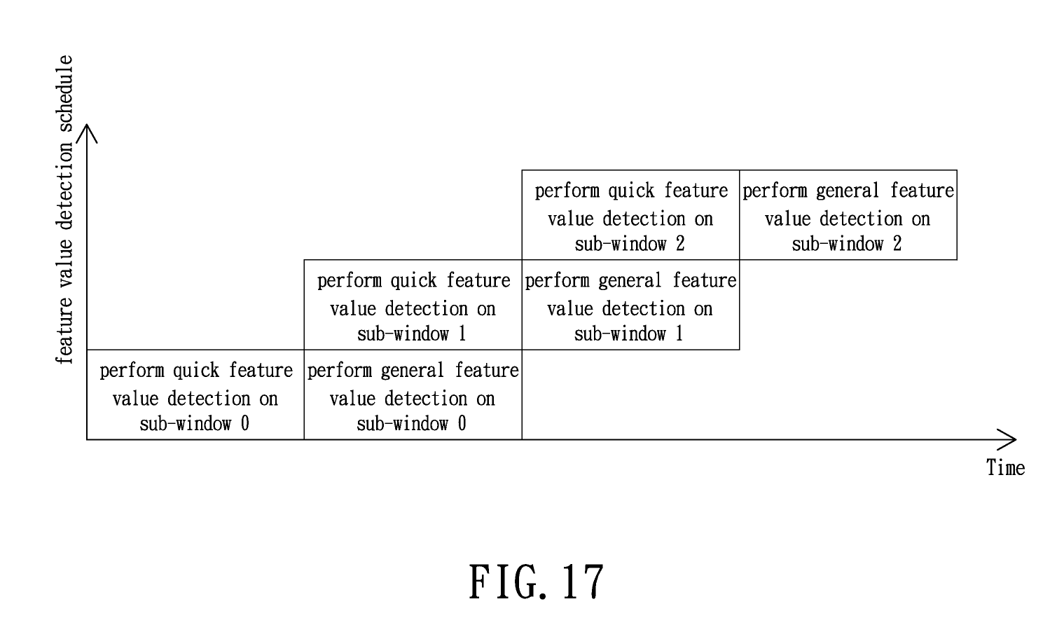

Referring to FIG. 17, a timing sequence diagram of the main control unit processing the sub-window image according to the first embodiment is illustrated. During a process of the feature value general detection unit 133 detecting the sub-window image which has a probability of containing the human face image one region after another, the feature value quick detection unit 132 continues to detect a next sub-window image and eliminate the sub-window image which do not contain the human face image. Once the feature value quick detection unit 132 detects or finds the sub-window image which has a probability of containing the human face image, then stopping the detection process and waiting for the feature value general detection unit 133 to finish the general detection, and then loads the sub-window image which has a probability of containing the human face image into the feature value general detection unit 133 to run a next general detection. After this, the feature value quick detection unit 132 continues to run the detection process. Because the feature value general detection unit 133 detects the sub-window image one region after another, so a detecting time is relatively long. However, in the present embodiment, during the feature value general detection unit 133 detecting the sub-window image, the feature value quick detection unit 132 simultaneously detects and eliminates the sub-window image which do not contain the human face image, thus the detecting speed and detecting efficiency are greatly improved.

Alternatively, the feature value quick detection unit 132 can directly detect all of the sub-window images in a whole image, eliminate the sub-window image which do not contain the human face image, and deposit the sub-window image which has a probability of containing the human face image into a memory. Similarly, the feature value general detection unit 133 can direct access and detect the sub-window image which has a probability of containing the human face image into deposited in the memory. In this detecting process, the feature value quick detection unit 132 does not need to wait for the feature value general detection unit 133 finishing its detection process, that is, the feature value quick detection unit 132 and the feature value general detection unit 133 can run the detection process simultaneously, thereby the detecting efficiency is greatly improved.

In summary, in the embodiments of the present invention, multiple registers are used to simultaneously/parallel process and compute the stored values of the pixels in the sub-window image, the computing speed of the image integral computing unit is multiplicatively quickened. In the process of the image integral computing unit computing the integral matrix of image pixels, the multi-bit registers are used to register intermediate results, thus the stored value of each pixel II(x, y) does not need to be recalculated by the reiteration manner, greatly saving the reiteration steps and quickening the computing speed of the image integral computing unit. Because the computing speed is greatly quickened, a relative low speed processor and low capacity memory can be applied to the present human face detection system, thereby lowering a cost of the system. In addition, the image integral computing unit has a simple configuration and is easy to integrate with the integrate circuit, so as to miniaturize the human face detection system and lower the cost thereof, thereby achieving a better practicability.

Regarding the human face detection system of the present invention, the feature value quick detection unit and the feature value general detection unit cooperatively detect the sub-window image, the sub-window images which do not contain the human face image are rapidly eliminated by the feature value quick detection unit; the feature value quick detection unit and the feature value general detection unit can simultaneously run the detection process, so the detecting speed and efficiency of the human face detection system are greatly improved, thereby causing the human face detection system having better practicability and better performance of on-line detection. In addition, the feature value calculator can be made of an integrate circuit, so a compact structure and a high computing speed are acquired. The processed sub-window image is saved in the image memory by the local storage manner, which facilitates sequential units access the sub-window image data, thereby improving a running efficiency of the human face detection system.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A human face detection system, comprising:
an image processing unit configured for dividing a sub-window image into M×N numbers of pixel regions and evaluating each of the pixel region, thereby outputting a processed result;
an image integral computing unit comprising multiple registers for parallel computing the processed result, thereby outputting a computed result; and
a human face detection unit configured for detecting and judging whether or not the computed result contains a human face image.

2. The human face detection system as claimed in claim 1, wherein the image processing unit further comprises:
a re-sampling unit configured for dividing the sub-window image into M×N numbers of pixel regions and evaluating each of the pixel region, thereby outputting the processed result;
a main control unit configured for receiving external images and communication signals, and controlling the re-sampling unit, the image integral computing unit and the human face detection unit; and
an image memory configured for storing the processed result outputted by the re-sampling unit.

3. The human face detection system as claimed in claim 1, wherein the image integral computing unit further comprises:
a first register containing M numbers of stored values;
a second register configured for reading I numbers of pixels from the sub-window image comprising M×N numbers of pixels, I being a positive integer that greater than 1 and less than M×N, M and N are positive integers that greater than 1; and
an adder configured for separately adding I numbers of pixels and corresponding I numbers of stored values in the first register so as to acquire I numbers of adding calculation values, returning the I numbers of adding calculation values to the first register and saving as I numbers of stored values.

4. The human face detection system as claimed in claim 3, wherein the adding calculation values comprises an integral matrix, an accumulated value and a sum of square value of pixels.

5. The human face detection system as claimed in claim 4, wherein the human face detection system further comprises a feature value calculator, according to the integral matrix, the feature value calculator computes a given rectangle region in the sub-window image and outputs a feature value corresponding to the given rectangle region.

6. The human face detection system as claimed in claim 5, wherein the human face detection system further comprises a feature value quick detection unit, and the feature value quick detection unit detects and judges the sub-window image according to the accumulated value, a sum of square value and the feature value of pixels of the given rectangle region in the sub-window image.

7. The human face detection system as claimed in claim 6, wherein the human face detection system further comprises a feature value general detection unit, and the feature value general detection unit detects and judges the sub-window image according to the feature value of pixels of the given rectangle region in the sub-window image.

8. The human face detection system as claimed in claim 7, wherein the human face detection system further comprises a feature value data sheet memory configured for providing a predetermined reference feature value for the feature value quick detection unit and the feature value general detection unit.

9. An image processing apparatus, comprising:
a first register comprising M numbers of stored values, wherein an initial value of each of the M numbers of stored values is zero;
a second register configured for reading I numbers of pixels from a sub-window image comprising M×N numbers of pixels, I being a positive integer that greater than 1 and less than M×N, M and N are positive integers that greater than 1; and
an adder configured for separately adding I numbers of pixels read by the second register and corresponding I numbers of stored values in the first register so as to acquire I numbers of adding calculation values, returning the I numbers of adding calculation values to the first register and saving as I numbers of stored values.

10. The image processing apparatus as claimed in claim 9, wherein the image processing apparatus further comprises a first memory, M numbers of stored values are stored in the first memory.

11. The image processing apparatus as claimed in claim 9, wherein the image processing apparatus further comprises a second memory, I adding calculation values are stored in the second memory.

12. The image processing apparatus as claimed in claim 9, wherein the image processing apparatus further comprises:
an accumulated value register, wherein the adder adds I numbers of pixels read by the second register and I numbers of stored values in the accumulated value register so as to acquire an accumulated value, the accumulated value returned to the accumulated value register and is saved as a stored value of the accumulated value register.

13. The image processing apparatus as claimed in claim 12, wherein the image processing apparatus further comprises:
a sum of square register;
a multiplier for square calculating the accumulated values to acquire a square value;
a sum of square adder for adding the square value and a stored value stored in the sum of square register to acquire a sum of square value, wherein the sum of square value is returned to the sum of square register and is saved as a stored value of the sum of square register.

14. The image processing apparatus as claimed in claim 12, wherein the adder further comprise a first adder and a second adder, the first adder is used to add I numbers of pixels read by the second register and I numbers of stored values in the first register, and the second adder is used to add I numbers of pixels read by the second register and the stored value in the accumulated value register.

15. The image processing apparatus as claimed in claim 9, wherein the image processing apparatus further comprises:
an accumulated value register region disposed in the second register, wherein the adder adds I numbers of pixels read by the second register and the stored value in the accumulated value register to acquire an accumulated value, the accumulated value is returned to the accumulated value register region and is saved as a stored value of the accumulated value register region.

16. The image processing apparatus as claimed in claim 15, wherein the image processing apparatus further comprises:
a sum of square register region disposed in the second register;
a multiplier for square calculating the accumulated values to acquire a square value; and
a sum of square adder for adding the square value and a stored value stored in the sum of square register region to acquire a sum of square value, wherein the sum of square value is returned to the sum of square register region and is saved as a stored value of the sum of square register region.

17. The image processing apparatus as claimed in claim 15, wherein the adder further comprises a first adder and a second adder, the first adder is used to add I numbers of pixels read by the second register and I numbers of stored values in the first register, and the second adder is used to add I numbers of pixels read by the second register and the stored value in the accumulated value register.

18. The image processing apparatus as claimed in claim 9, wherein the image processing apparatus further comprises:
a discrete quantity register; and
a discrete quantity computing unit configured for applying a discrete quantity calculation to I numbers of pixels read by the second register and a stored value stored in the discrete register, thereby acquiring a discrete quantity calculation value, wherein the discrete quantity calculation value is returned to the discrete quantity register and is saved as a stored value of the discrete quantity register.

19. The image processing apparatus as claimed in claim 9, wherein the image processing apparatus further comprises:
a discrete quantity register region; and
a discrete quantity computing unit configured for applying a discrete quantity calculation to I numbers of pixels read by the second register and a stored value stored in the discrete register region, thereby acquiring a discrete quantity calculation value, wherein the discrete quantity calculation value is returned to the discrete quantity register region and is saved as a stored value of the discrete quantity register region.

20. The image processing apparatus as claimed in claim 9, wherein the image processing apparatus further comprises:
a sum of square register;
a multiplier for square calculating I numbers of pixels read by the second register to acquire I numbers of square values; and
a sum of square adder for adding I numbers of square values and stored values stored in the sum of square register to acquire a sum of square value, wherein the sum of square value is returned to the sum of square register and is saved as a stored value of the sum of square register.

21. The image processing apparatus as claimed in claim 9, wherein the image processing apparatus further comprises:
a sum of square register region disposed in the second register;
a multiplier for square calculating I numbers of pixels read by the second register to acquire I numbers of square values; and
a sum of square adder for adding I numbers of square values and stored values stored in the sum of square register region to acquire a sum of square value, wherein the sum of square value is returned to the sum of square register region and is saved as a stored value of the sum of square register region.

22. An image processing method, comprising the steps of:
providing a sub-window image containing M×N numbers of pixels, M and N being positive integers that greater than 1;
providing a first register containing M numbers of stored values;
reading I numbers of pixels from the sub-window image, I being a positive integer that greater than 1 and less than M×N; and
performing a first operation, adding stored values of I numbers of pixels read by the second register and I numbers of stored values in the first register to acquire I numbers of adding calculation values, returning the I numbers of adding calculation values to the first register and saving the I numbers of adding calculation values as I numbers of stored values of the first register.

23. The image processing method as claimed in claim 22, further comprising the steps of:
providing an accumulated value register; and
performing a second operation, adding stored values of I numbers of pixels read by the second register and stored values in the accumulated value register to acquire an accumulated value, returning the accumulated value to the accumulated value register and saving the accumulated value as a stored value of the accumulated value register.

24. The image processing method as claimed in claim 23, further comprising the steps of:
providing a sum of square register;
square calculating the accumulated value to acquire a square value; and
adding the square value and a stored value in the sum of square register to acquire a sum of square calculation value, returning the sum of square calculation value to the sum of square register and saving the sum of square calculation value as a stored value of the sum of square register.

25. The image processing method as claimed in claim 23, further comprising the steps of:
providing a discrete quantity register; and
performing a third operation, adding stored values of I numbers of pixels read by the second register and a stored value stored in the discrete register to acquire a discrete quantity calculation value, returning the discrete quantity calculation value to the discrete quantity register and saving the discrete quantity calculation value as a stored value of the discrete quantity register.

26. The image processing method as claimed in claim 23, further comprising the steps of:
providing a sum of square register;
square calculating I numbers of pixels read by the second register to acquire I numbers of square values; and
adding I numbers of square values and a stored value in the sum of square register to acquire a sum of square calculation value, returning the sum of square calculation value to the sum of square register and saving the sum of square calculation value as a stored value of the sum of square register.

27. The image processing method as claimed in claim 23, further comprising the steps of:
providing a first memory containing M×N numbers of stored values; and
saving M×N numbers of pixels of the sub-window as M×N numbers of stored values of the first memory.

28. The image processing method as claimed in claim 23, further comprising the steps of:
providing a second memory containing M×N numbers of stored values; and
according a timing order, storing I numbers of adding calculation values acquired by performing the first operation each time into I numbers of stored values of M×N numbers of stored values in the second memory.

29. A human face detection method, comprising the steps of:
providing a sub-window image;
dividing the sub-window image into M×N numbers of pixels and evaluating each of the pixel to acquire a processed result;
computing the processed result by an image integral computing unit comprising multiple registers, thereby acquiring an integral matrix, an accumulated value of pixels and a sum of square value of pixels;
according to the integral matrix, computing a given rectangle region of the sub-window image to acquire a feature value corresponding to the given rectangle region;
according to the feature value, the accumulated value of pixels and the sum of square value of pixels, applying a feature value quick detection step to the sub-window image and acquiring a detected result;
according to the detected result, computing M×N numbers of pixels of the sub-window image one by one, thereby acquiring M×N numbers of feature values; and
according to M×N numbers of feature values, applying a feature value general detection step to the sub-window image.

30. The human face detection method as claimed in claim 29, wherein the feature value quick detection step and the feature value general detection step run simultaneously.

31. The human face detection method as claimed in claim 29, wherein the feature value general detection step is used to further detect a result detected in the feature value quick detection step.
